(19) United States
(12) Patent Application Publication
(10) Pub. No.: US 2005/0039597 A1
(43) Pub. Date: Feb. 24, 2005

(54) MODULAR VALVE ASSEMBLY FOR A VACUUM BOOSTER

(75) Inventor: Michel J. Vermoesen, Miamisburg, OH (US)

Correspondence Address: SCOTT A. MCBAIN;DELPHI TECHNOLOGIES, INC., Legal Staff, Mail Code: 480-410-202, P.O. BOX 5052, Troy, MI, 48007, US

(73) Assignee: DELPHI TECHNOLOGIES INC.

(21) Appl. No.: 10/643,258

(22) Filed: Aug. 19, 2003

(51) Int. Cl. F15B 9/10

(52) U.S. Cl. 91/376 R

(57) ABSTRACT

A vacuum booster and method includes a modular valve assembly having components held together by a snap connection. The modular valve assembly, includes an air valve adapted for receiving a push rod, a floating control valve (FCV), an air valve spring, a floating control valve (FCV) spring, an FCV support, and a spring seat. The spring seat is operatively attached by a snap connection to the air valve, and retains the FCV, air valve spring, FCV support, and FCV spring between the spring seat and the air valve. A second snap connection is utilized for attaching a push rod after the modular valve assembly is installed into a booster. The push rod may be installed after the otherwise fully assembled booster, including the modular valve assembly, has been tested.

### TECHNICAL FIELD OF THE INVENTION

This invention relates to vacuum brake boosters, and more particularly to a modular valve assembly for a vacuum brake booster.

### BACKGROUND OF THE INVENTION

Vehicles such as automobiles, trucks, buses, and motor homes typically include a dashboard at the front of the passenger compartment, having a power brake booster on the front of the dashboard connected by a push rod to a brake pedal mounted on the rear of the dashboard in the passenger compartment.

FIG. 1 shows one commonly used type of brake booster 100, known as a tandem vacuum brake booster. The booster 100 includes a housing assembly 102, having a rear housing 104 adapted for connection to the front of the dashboard, and a front housing 106 adapted to receive and provide a mounting surface for a master cylinder 108 of the brake system. The housing assembly 102 of the vacuum booster 100 includes a divider 110 that divides the interior of the housing assembly into a primary chamber 112 and a secondary chamber 114, and provides sliding support for an axially movable booster power piston 116 that is connected via the push rod 118 to the brake pedal 120.

Extending radially outward from the power piston 116, in the secondary chamber 114 of the housing 102, is a secondary diaphragm support 122. In similar fashion, a primary diaphragm support 124 extends radially outward from the power piston 116 in the primary chamber 112. The primary and secondary diaphragm supports 122, 124 are fixed to the power piston 116 and move axially along an axis of motion 126 with the power piston 116.

A flexible secondary diaphragm 128 has an outer periphery sealed to the inner walls of the secondary chamber 114 of the front housing 106, and an inner periphery sealed to the power piston 116, to thereby form a secondary low pressure chamber 130 between the secondary diaphragm 128 and the front wall 132 of the front housing 106 and a secondary high pressure chamber 134 between the secondary diaphragm 128 and the divider 110.

A flexible primary diaphragm 136 has an outer periphery sealed to the inner wall of the primary chamber 112 of the rear housing 102, and an inner periphery sealed to the power piston 116, to thereby form a primary low pressure chamber 138 between the primary diaphragm 136 and the divider 110, and a primary high pressure chamber 140 between the primary diaphragm 136 and the rear wall 142 of the rear housing 102. One or more air tubes 144 extend through the primary low pressure chamber 138 to connect the primary and secondary high pressure chambers 140, 134. The primary and secondary low pressure chambers 138, 130 are connected by holes 146 passing through the power piston 116.

The booster 100 includes valve elements, indicated generally by arrow 148, operably attached to the push rod 118 within the power piston 116, for selectively connecting all four chambers 138, 140, 130, 134 (i.e. the primary low pressure, secondary low pressure, primary high pressure, and secondary high pressure chambers) to a source of vacuum (not shown), such as the interior passages of an engine intake manifold, when the brake pedal 120 is not depressed. When the brake pedal 120 is depressed, the push rod 118 moves the valve elements 148 to a position where the primary and secondary low pressure chambers 138, 130 remain connected to the source of vacuum, but the primary and secondary high pressure chambers 140, 134 are connected to atmospheric air pressure around the brake booster 100.

The difference in pressure between the atmospheric pressure operating against the rear side of the primary and secondary diaphragms 136, 128, and the vacuum operating against the front side of the primary and secondary diaphragms 136, 128, generates a force against the primary and secondary diaphragm supports 124, 122 that drives the power piston 116 forward, (to the left in FIG. 1) and augments the force exerted through the push rod 118 from the brake pedal 120, acting through an internal booster push rod 150 in moving a hydraulic piston 152 in the master cylinder 108 to generate hydraulic pressure in the brake system for applying the brakes. The action of the brake booster 100 thus allows the pedal force required to generate a desired hydraulic pressure in the master cylinder 108 to be significantly less than the pedal force that would be required without the booster 100.

When the brake pedal 120 is released, after a braking event, a booster return spring 154 disposed between the front housing 106 and the power piston 116 causes the power piston 116 to move back to poise position, illustrated in FIG. 1. As the return spring 154 drives the power piston 116 back to the poise position, the valve elements 148 are momentarily positioned, as a result of the motion of the power piston and the action of springs within the valve elements, to allow the air in the primary and secondary high pressure chambers 140, 130 to escape through the valve elements 148. Once the air has escaped, the valve elements 148 return to a poised position, as shown in FIG. 1, that allows the primary and secondary high pressure chambers 140, 130 to be evacuated by the source of vacuum, to thereby equalize pressure across the primary and secondary diaphragms 136, 128.

The configuration and operation of the valve elements 148 varies considerably, between boosters 100 manufactured by different suppliers. In many prior boosters, the valve elements are individually installed into the power piston during assembly of the booster. This method of manufacture is time consuming, and fraught with the potential for errors that can result in scrapping an entire booster. It is highly desirable that as many of the valve elements as possible be assembled into a modular valve assembly, that can be built and tested off of the booster assembly line, and then installed as a unit into the booster power piston, during final assembly of the booster.

The booster 100, of FIG. 1, includes a modular valve assembly 156, shown enlarged in FIG. 2, and exploded in FIG. 3, incorporating the valve elements 148 and the push rod 118. The modular valve assembly 156 includes an air valve 158, a floating control valve (FCV) 160, an air valve spring 162, a floating control valve (FCV) spring 164, a spring seat 166, and a floating control valve (FCV) support 168. The air valve 158 has one end (right end as shown) adapted for receiving the push rod 118, and a second end (left as shown) adapted to bear against the booster internal push rod 150.

In the modular valve assembly 156, the air valve 158 and spring seat 166 are not attached directly to one another, but in conjunction with a shoulder 170 on the push rod 118, and a ball end 172 on the push rod 118 held in a receptacle 174 of the air valve by a crimped connection 176 (as shown in FIGS. 1 and 2), serve to hold the components 158, 160, 162, 164, 166, 168, 118 of the modular valve assembly 156 together as an integral subassembly. As shown in FIG. 1, the modular valve assembly 156 is installed into the power piston 116, and retained therein by an air valve retaining clip 178 that engages an annular groove in the air valve 158. The FCV support 168 also engages the power piston 116 to position the modular valve assembly 156 inside of the power piston 116 in such a manner that the outer periphery of the floating control valve (FCV) 160 is brought to bear against an annular power piston v-seat 180 of the power piston 116.

The components 158, 160, 162, 164, 166, 168, 118 of the modular control valve 156 are assembled by aligning them as shown in FIGS. 1-3, along a valve assembly axis 182 which is coincident with the axis of motion 126 of the booster 100, pressing on the push rod 118 to compress the FCV spring 164 and air valve spring 162 to properly position the ball end 172 of the push rod 118 in the receptacle 174 of the air valve 158, and forming the crimped connection 176. The crimped connection 176 is formed, with the components 158, 160, 162, 164, 166, 168, 118 held in a fixture, by separating the FCV 160 and the air valve 158, far enough from one another to insert punches into the gap formed between the FCV 160 and the air valve 158, for partially deforming the wall of the air valve 158 surrounding the receptacle, 174 to form the crimped connection 176.

Although the modular valve assembly 156 described above provides considerable advantage over other approaches wherein the valve elements 148 are individually installed into a booster, it is desirable to provide an improved modular valve assembly that does not require the crimped connection 176. In the process of lifting and holding the FCV 160 off of the air valve 158 during formation of the crimped connection, the FCV 160 can be damaged. Obtaining a proper fit between the ball end 172 of the push rod 118 and the receptacle 174 of the air valve 158 involves considerable difficulty.

It is also desirable that an improved modular valve assembly not include the push rod 118, and that the push rod 118 be installable into the booster 100 after the improved modular valve assembly is installed into the booster 100, and the booster 100 has been tested. Having the push rod 118 separable from the improved modular valve assembly provides considerable advantage, in that inventory can be reduced and assembly and test facilitated. Different vehicle makes and models, using boosters 100 that are otherwise identical, often require different push rods 118 unique to each vehicle. By having the push rod 118 be installable after the booster 100 is otherwise complete and tested, it is not necessary to stock a large number of variations of modular valve assemblies 156 and boosters 100, differing from one another only by having different push rods 118.

### SUMMARY OF THE INVENTION

The present invention provides an improved booster and modular valve assembly, meeting the requirements discussed above, through use of a snap connection to hold the components of the modular valve assembly together.

In one form of the invention, a modular valve assembly, for a power piston in a vacuum booster, includes an air valve adapted for receiving a push rod, a floating control valve (FCV), an air valve spring, a floating control valve (FCV) spring, and a spring seat. The spring seat is operatively attached by a snap connection to the air valve, and retains the FCV, air valve spring, and FCV spring between the spring seat and the air valve. The modular valve assembly may also include a floating control valve (FCV) support connected to the floating control valve. The modular valve assembly may also include a second snap connection for attaching a push rod after the modular valve assembly is installed into a booster. The push rod may be installed after the otherwise fully assembled booster, including the modular valve assembly, has been tested.

In some forms of the invention, the air valve and spring seat are attached directly to one another by a snap connection. In other forms of the invention, the air valve and spring seat are operatively attached to one another by a push rod having a ball end thereof connected to the air valve by a snap connection.

The modular valve assembly may also include a retaining clip for making the snap connection between the push rod and the air valve. This clip may be fabricated entirely from metal in a manner that provides better performance and a self-compensating fit between the push rod and the air valve.

The present invention may also take the form of a method for assembling a booster and/or a modular valve assembly of the type described herein.

The foregoing and other features and advantages of the invention will become further apparent from the following detailed description of exemplary embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic cross section of a prior vacuum brake booster having a modular valve assembly, held together by a crimped connection;

FIG. 2 is an enlarged partial cross section of the modular valve of the prior booster of FIG. 1;

FIG. 3 is an exploded enlarged view of the modular valve of the prior booster of FIG. 1;

FIG. 4 is an enlarged cross sectional view of a booster according to the present invention, including a first embodiment of a modular valve assembly held together by a snap conection;

FIG. 5 is cross section of the modular valve assembly of FIG. 4,

FIG. 6 is an exploded view of the modular valve assembly of FIG. 4;

FIGS. 7 and 8 show operating modes of the first exemplary embodiment of FIG. 4;

FIG. 9 is a perspective view of a snap connection, according to the invention, for attaching a push rod to the modular valve assembly of FIGS. 3-8;

FIG. 10 is a split cross sectional view showing variations of snap connections in the first embodiment of the invention as shown in FIGS. 3-9; and

FIG. 11 is a split cross sectional view of a second exemplary embodiment of the invention, showing variations of a snap connection in a modular valve assembly according to the second embodiment of the invention.

Throughout the following description of exemplary embodiments of the invention, components and features that are substantially equivalent or similar will be identified in the drawings by the same reference numerals. For the sake of brevity, once a particular element or function of the invention has been described in relation to one exemplary embodiment, the description and function will not be repeated for elements that are substantially equivalent or similar in form and/or function to the components previously described, in those instances where the alternate exemplary embodiments will be readily understood by those skilled in the art from a comparison of the drawings showing the various exemplary embodiments in light of the description of a previously presented embodiment.

### DETAILED DESCRIPTION

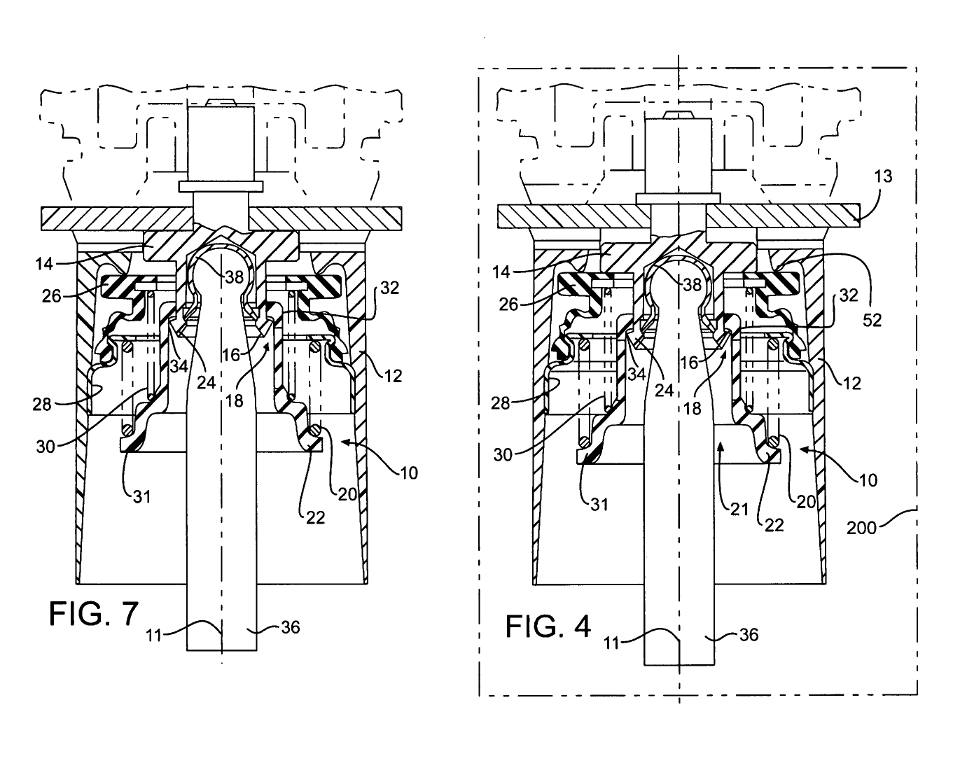

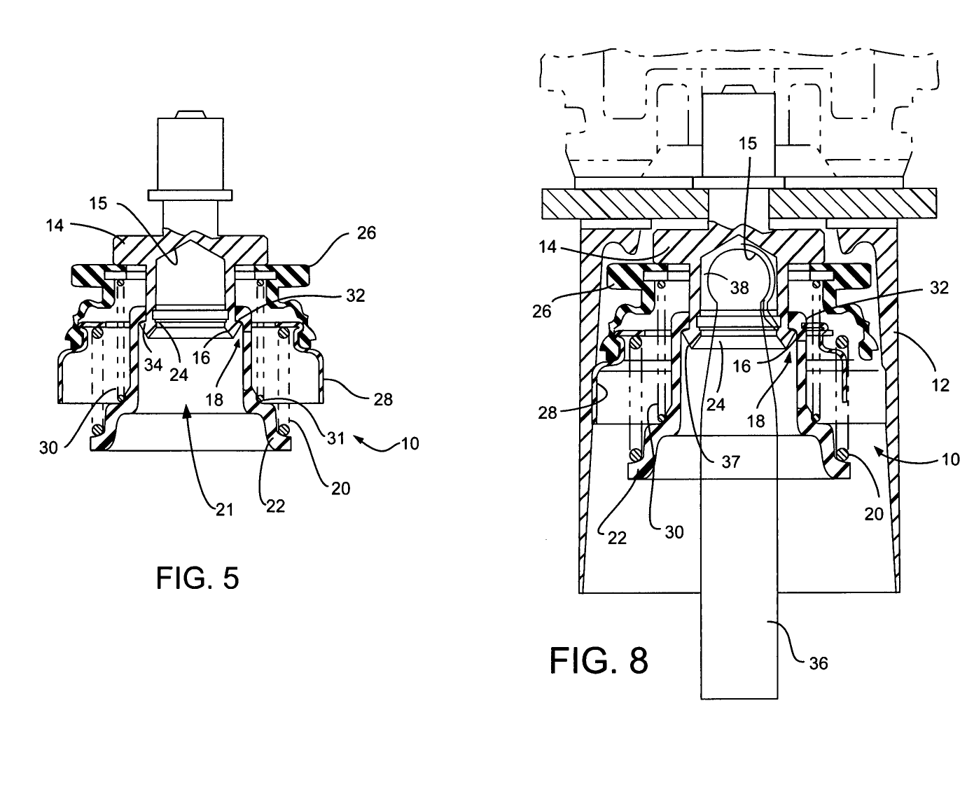

FIG. 4 shows a first exemplary embodiment of the invention in the form of a vacuum booster 200 including a modular valve assembly 10, as shown in FIGS. 4 and 5, in a power piston 12 of the booster 200. The modular valve assembly 10 includes an air valve 14 adapted for receiving a push rod 36, a floating control valve (FCV) 26, an air valve spring 30, a floating control valve (FCV) spring 20, and a spring seat 22. The spring seat 22 is operatively attached by a snap connection 18 to the air valve 14, and retains the FCV 26, air valve spring 20, and FCV spring 30 between the spring seat 22 and the air valve 14.

The exemplary first embodiment of the modular valve assembly 10 also includes a floating control valve (FCV) support 28. The modular control valve 10 is retained and positioned within the power piston 12 by an air valve retaining clip 13, and the FCV support 28 in the same manner as described above, with regard to the prior modular valve assembly 156.

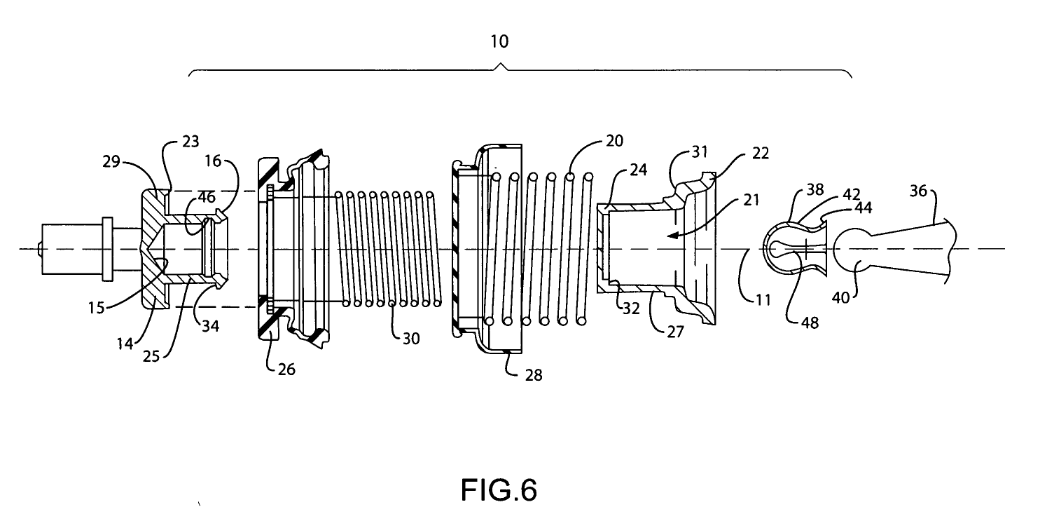

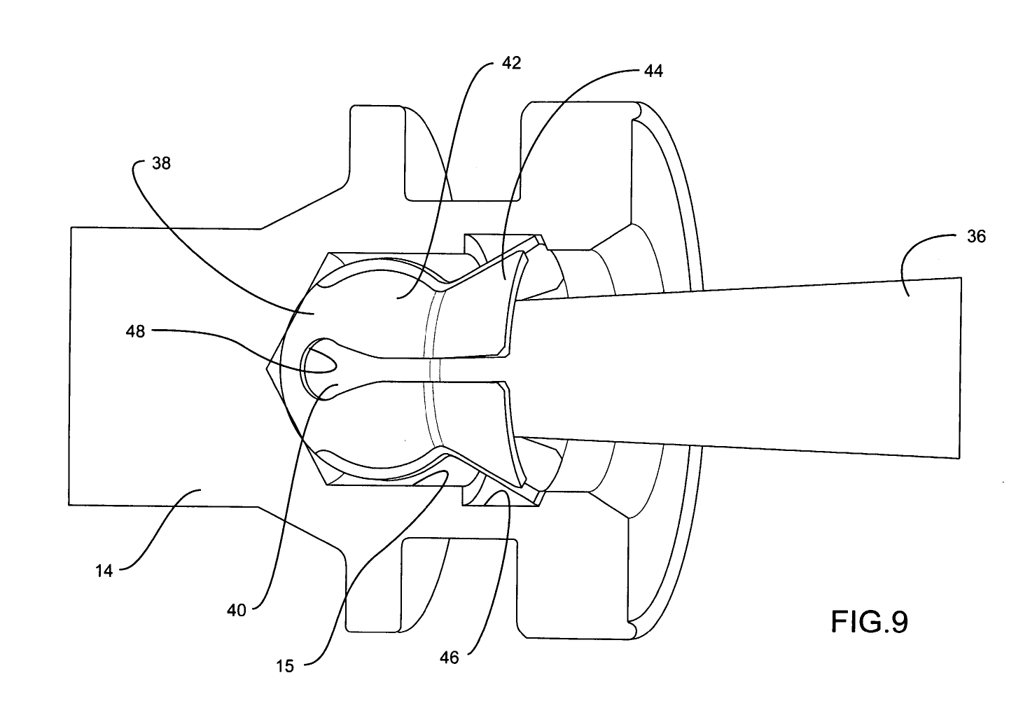

In the first exemplary embodiment, shown in FIGS. 4-10, the air valve 14 and spring seat 22 are attached directly to one another by a snap connection 18. The air valve 14 includes an annular, v-shaped, air valve seat 23 for sealing engagement with the inner periphery of one end of the floating control valve 26, and a first portion 16 of the snap connection 18, extending from the air valve seat 14. The spring seat 22 includes a second portion 24 of the snap connection 18, extending from the spring seat 22. The second portion 24 of the snap connection 18 is adapted for engaging the first portion 16 of the snap connection 18, to thereby form the snap connection 18 between the air valve 14 and the spring seat 22.

The modular valve assembly 10 defines an axis of motion 11, which extends essentially coincident with an axis of motion of the booster 200. The air valve 14 includes a radially extending flange 29, and the first portion 16 of the snap connection 18 includes a generally tubular collar 25 extending from the radially extending flange 29 along the axis of motion 11 toward the spring seat 22. The tubular collar 25 of the air valve 14 includes an outwardly extending catch 34. The spring seat 22 also includes a generally tubular collar 27 extending along the axis of motion 11. The generally tubular collar 27 of the spring seat 22 is sized to slide over the tubular wall 25 extending from the air valve 14, and includes an inwardly extending catch 32 adapted for snapping engagement with the outwardly extending catch 34 on the air valve 14. The tubular collars 27, 25 on the spring seat 22 and air valve 14 are configured for allowing sliding movement of the air valve 14 and spring seat 22, with respect to one another along the axis of motion 11, after the snap connection 18 is made between the air valve 14 and spring retainer 22.

The spring seat 22 includes an axially extending opening 21 for passage therethrough of the push rod 36 without contact between the push rod 36 and the spring seat 22. The spring seat 22 also includes a radially extending flange 31 for retaining the FCV spring 30 between the flange 29 and the FCV 26, to thereby urge the FCV 26 to move along the axis of motion 11 toward the air valve seat 23 on the flange 29 of the air valve 14. The flange 31 of the spring seat 22 further retains the air valve spring 20 between the flange 31 and the FCV support 28, to thereby urge the spring retainer 22 to move along the axis of motion 11 away from the FCV support 28, and through action of the snap connection 18, to pull the air valve 14 toward the FCV 26 and FCV support 28.

The air valve 14 of the first exemplary embodiment includes a receptacle 15 therein, opening along the axis of motion 11 for receiving the push rod 36. The modular valve assembly 10 further includes a retaining clip 38 in the receptacle 15 of the air valve 14 for engaging and connecting the push rod 36 to the air valve 14.

The push rod 36 includes a ball end 40 thereof for engaging the retaining clip 38. As shown, in FIGS. 4-10, the retaining clip 38 of the first embodiment includes a generally spherical portion 42 thereof for receiving the ball end 40, intersecting a truncated conical portion 44 thereof. The conical portion 44 has a minor diameter thereof connected to the spherical portion 42 and a major diameter thereof adapted for receiving the push rod 36 and for snap engagement with a groove 46 in the receptacle 15 of the air valve 14. The retaining clip 38 further includes slots 48 therein for allowing the retaining clip 38 to expand and snap back around the ball end 40 of the push rod 36, and snap into the groove 46 of the receptacle 15.

The invention provides a method for assembling a vacuum booster 200, by fabricating a modular valve assembly 10 as described above, including, an air valve 14 adapted for receiving a push rod 36, a floating control valve (FCV) 26, a floating control valve (FCV) support 28, an air valve spring 20, a floating control valve (FCV) spring 30, and a spring seat 22 operatively attached by a snap connection 18 to the air valve 14, with the snap connection 18 retaining the FCV 26, FCV support 28, air valve spring 20, and FCV spring 30 between the spring seat 22 and the air valve 14. The modular valve assembly 10 is then installed into the vacuum booster 200. The push rod 36 is attached to the vacuum booster 200, after the modular valve assembly 10 is installed in the vacuum booster 200, with a second snap connection 50 between the push rod 36 and the air valve 14. The push rod 36 may be attached with the second snap connection 50 at any time after assembly of the booster 200. The booster 200 can be tested prior to installing the push rod 36, by using a test push rod (not shown) that engages the receptacle 15 in the air valve 14.

FIGS. 4, 7, and 8 of show the position of the push rod 36, air valve 14 and floating control valve (FCV) 26 in various operational modes of the modular valve assembly 10. FIG. 4 shows the push rod 36, air valve 14 and floating control valve (FCV) 26 in what is known as a rest position, as would exist before the engine is started when no vacuum available inside the booster 200, and no force is being exerted on the brake pedal 120. When the engine is started, and vacuum is available at the booster 200, atmospheric air pressure acting on the right side (as shown in the FIGS.) of the FCV 26 will cause the FCV 26 to move to the left, and seat against an annular v-shaped power piston seat 52, to place the booster in what is known as a poised position.

As the brake pedal 120 is depressed from the poised position, the push rod will move the air valve 14 to the left, and the air valve seat 23 will pull away from the FCV 26, to allow atmospheric air to flow through the modular valve assembly 10 into the booster 200 so that the booster 200 can augment the force being exerted on the push rod 36 by the brake pedal 120. FIG. 7 shows the push rod 36, air valve 14 and floating control valve (FCV) 26 in what is known as a runout position, where the air valve 14 is completely open.

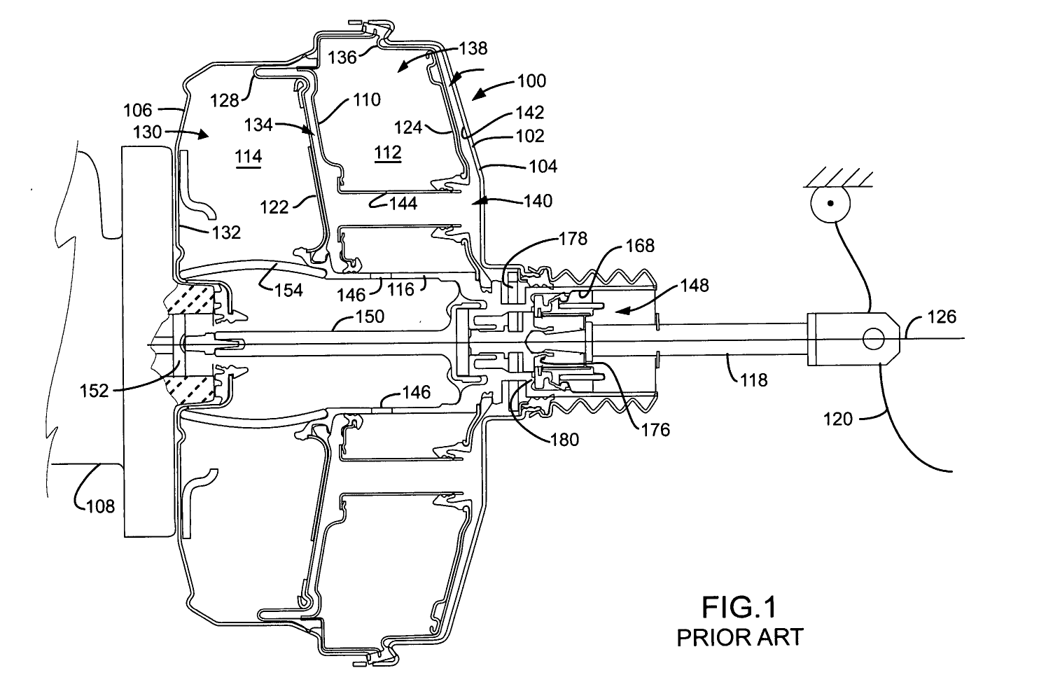

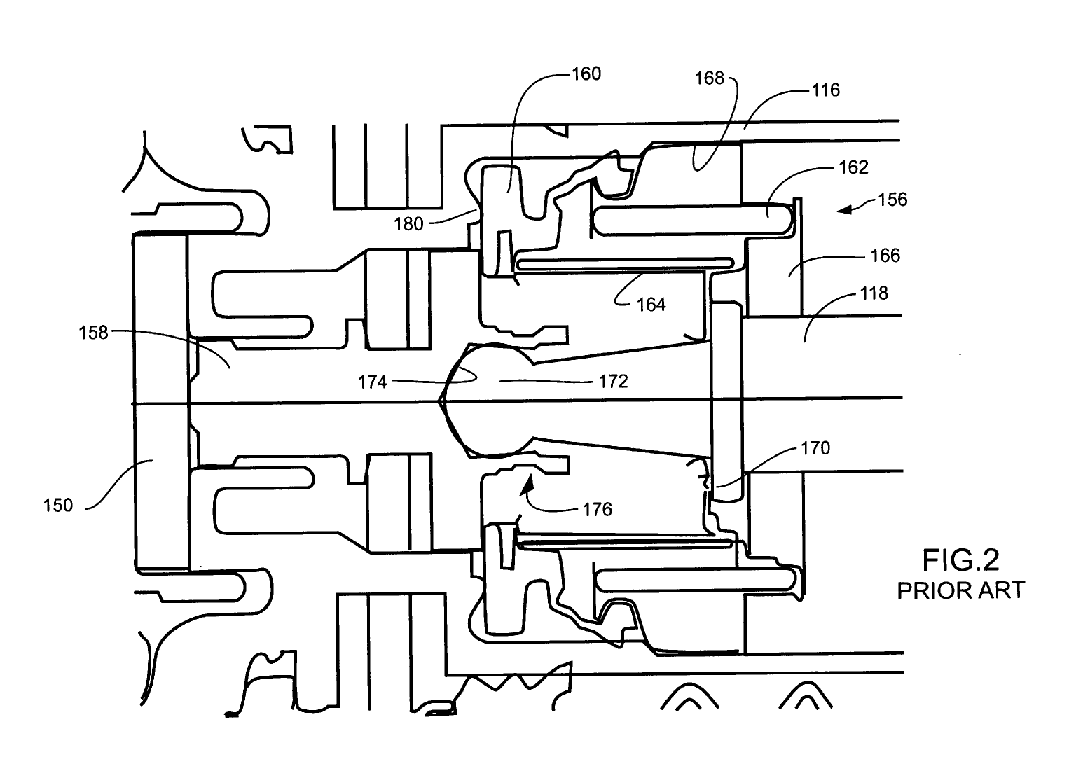

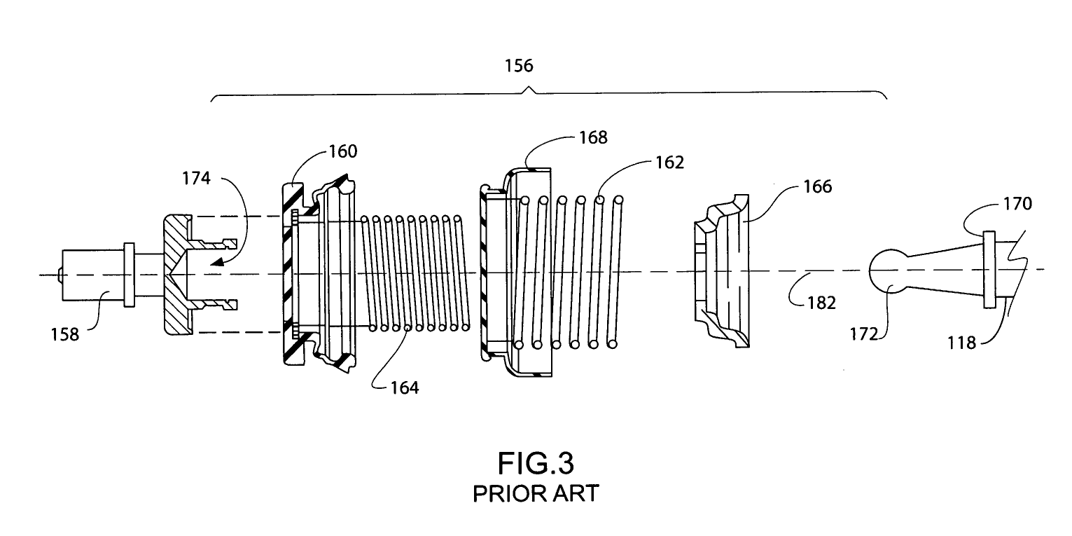

When force on the brake pedal 120 is released, a large booster return spring, like the spring 154 shown in FIG. 1, forces the power piston 12 back toward the brake pedal 120, and the air valve spring 20 causes the air valve 14 to re-engage the FCV 26 and lift the FCV off of the power piston seat 52, to allow the booster 200 to release and exhaust the air that entered the booster 200 during operation of the booster while the brake pedal was depressed. When the air is exhausted from the booster 200, the FCV spring 30 and pressure differential across the FCV 26 will cause the push rod 36, air valve 14 and floating control valve (FCV) 26 to move back to the poised position.

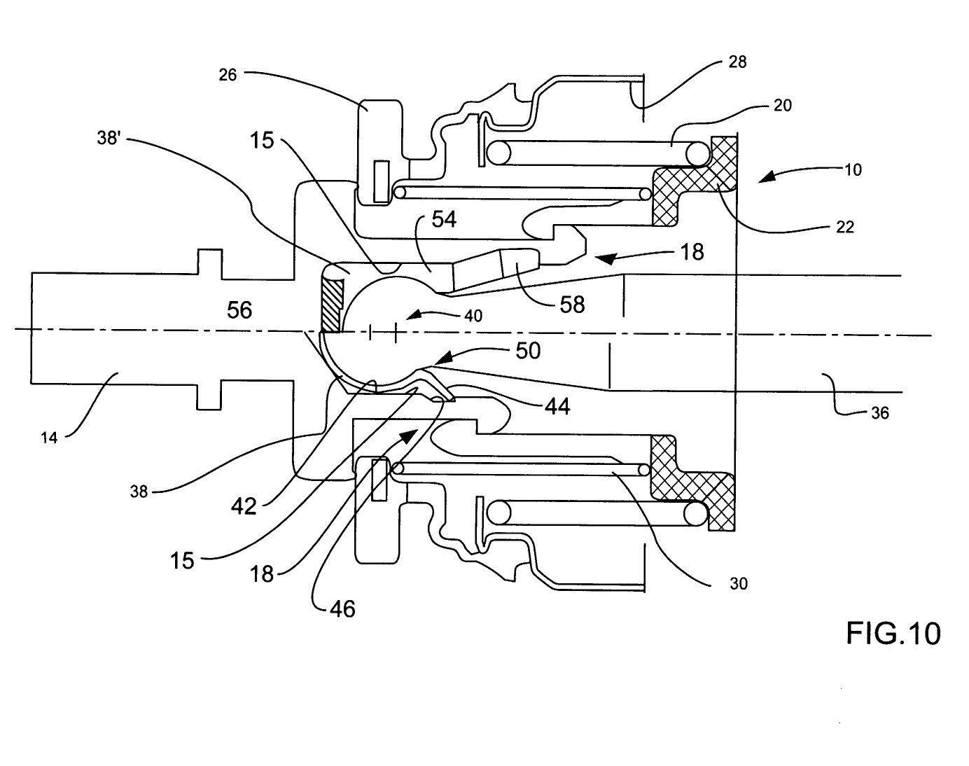

FIG. 10 is a split section view, showing the first embodiment of the modular valve assembly 10, with the spring seat 22 joined directly to the air valve 14 with a first snap connection 18, and the push rod 36 attached to the air valve with a second snap connection 50. The bottom half of FIG. 10 shows the push rod 36 attached to the air valve with a metallic clip 38 having a spherical portion 42 and a conical portion 44 engaging a groove 46 in the receptacle 15 of the air valve 14. The top half of FIG. 10 shows the push rod 36 attached to the air valve with an alternate embodiment of a retaining clip 38′ having a plastic portion 54 and a metal end plate 56. The plastic portion 54 includes a conical portion 58 engaging an alternate form of the groove 46 in the receptacle 15 of the air valve 14.

Although either clip 38 or clip 38′ can be used, the all metal clip 38 provides higher pull-out resistance. Higher pull-out resistance offers considerable advantage during installation of the booster into a vehicle, because installers typically pull on the push rod 36 when attempting to adjust the brake light switch, often leading to damage in prior booster approaches. The all-metal clip 38 also provides a self-compensating action, by virtue of the configuration of the clip 38, that provides considerable advantage and improved performance over the life of the booster, in comparison to prior boosters.

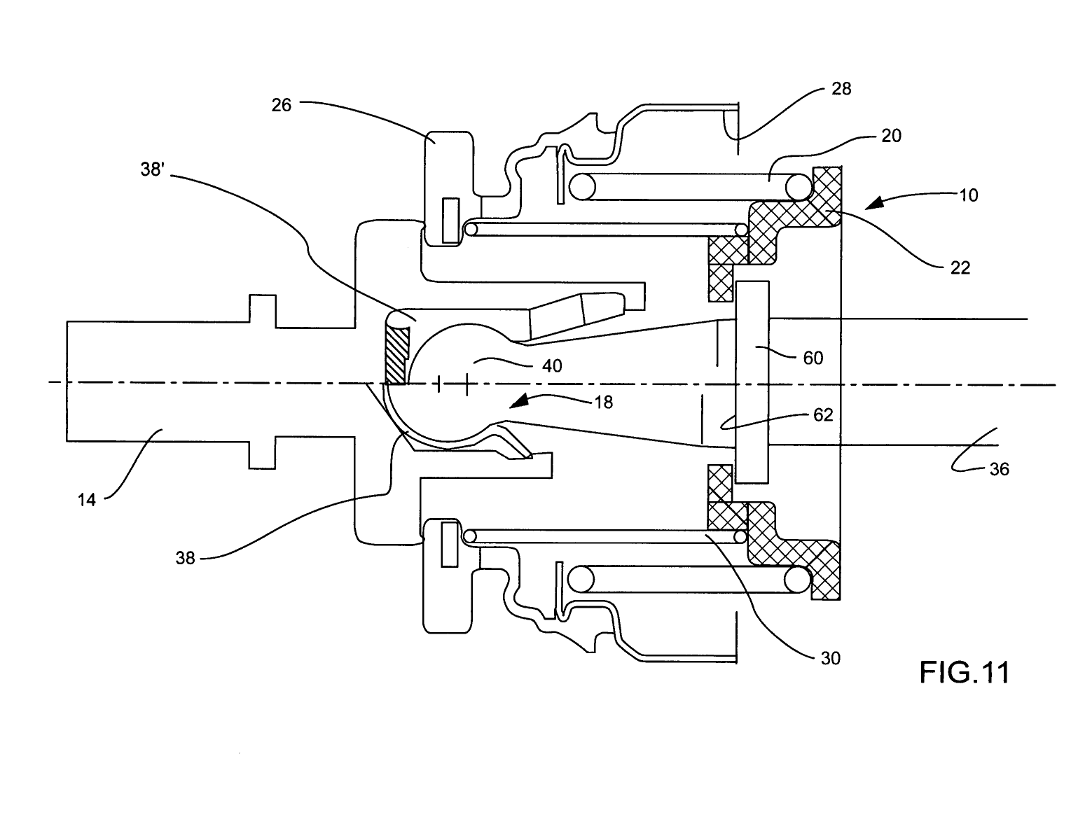

FIG. 11 is also a split sectional view of an alternate embodiment of the invention, where the snap connection 18 holding the components 14, 20, 22, 26, 20, 28 of the modular valve 10 uses the push rod 36 as part of the snap connection 18. The push rod 36 extends through the valve seat 22, and has a shoulder 62 formed by a radially extending flange 60, for engaging the spring seat 22 and a ball end 40 thereof for snap engagement with the air valve 14. The snap connection may be made with a retaining clip 38, a retaining clip 38′, or another form of a retaining clip.

The invention provides a method for assembling these alternate embodiments of the invention, where the push rod 36 has a ball end 40 configured for forming a snap connection to the air valve 14, and a flange 60 adapted for bearing against the spring seat 22. The method includes positioning the air valve 14, FCV 26, FCV support 28, FCV spring 30, air valve spring 20, and spring seat 22 in sequential alignment with one another, inserting the end of the push rod 36 through the FCV 26, FCV support 28, FCV spring 30, air valve spring 20, and spring seat 22, and completing the snap connection 18 of the end 40 of the push rod 36 with the air valve 14.

Those skilled in the art will readily recognize that, while the embodiments of our invention disclosed herein are presently considered to be preferred, various changes and modifications can be made without departing from the spirit and scope of the invention. For example, the invention can be utilized in a tandem booster 100, as shown in FIG. 1, or in other types of single stage or tandem vacuum boosters.

The scope of the invention is indicated in the appended claims, and all changes or modifications within the meaning and range of equivalents are intended to be embraced therein.

1. A modular valve assembly for a power piston in a vacuum booster, the modular valve assembly comprising:
an air valve adapted for receiving a push rod;
a floating control valve (FCV);
an air valve spring;
a floating control valve (FCV) spring; and
a spring seat operatively attached by a snap connection to the air valve, and retaining the FCV, air valve spring, and FCV spring between the spring seat and the air valve.

2. The modular valve assembly of claim 1, further comprising a floating control valve (FCV) support connected to the floating control valve.

3. The modular valve assembly of claim 2, wherein the air valve and spring seat are attached directly to one another by a snap connection.

4. The modular air valve assembly of claim 3 wherein:
the air valve includes an air valve seat for sealing engagement with the floating control valve, and a first portion of a snap coupling extending from the air valve seat; and
the spring seat includes a second portion of a snap coupling extending therefrom adapted for engaging the first portion of the snap coupling, to thereby form the snap connection between the air valve and the spring seat.

5. The modular valve assembly of claim 4 defining an axis of motion thereof, and wherein:
the air valve includes a radially extending flange defining the air valve and the first portion of the snap coupling includes a generally tubular collar extending from the radially extending flange along the axis of motion toward the spring seat, the tubular collar including an outwardly extending catch; and
the spring seat includes a generally tubular collar extending along the axis of motion, the generally tubular collar of the spring seat including an inwardly extending catch adapted for snapping engagement with the outwardly extending catch on the air valve;
the tubular collars on the spring seat and air valve configured for allowing movement of the air valve and spring seat with respect to one another along the axis of motion after the snap connection is made between the air valve and spring retainer.

6. The modular valve assembly of claim 5 wherein the spring seat includes a flange for retaining the FCV spring between the flange and the FCV, to thereby urge the FCV to move along the axis of motion toward the air valve seat on the air valve.

7. The modular valve assembly of claim 6 wherein the flange of the spring seat further retains the air valve spring between the flange and the FCV support, to thereby urge the spring retainer to move along the axis of motion away from the FCV support, and through the snap connection to pull the air valve toward the FCV and FCV support.

8. The modular valve assembly of claim 7 wherein:
the air valve includes a receptacle therein opening along the axis of motion for receiving the push rod; and
the modular valve assembly further includes a retaining clip in the receptacle of the air valve for engaging and connecting the push rod to the air valve.

9. The modular valve assembly of claim 8 wherein:
the push rod includes a ball end thereof for engaging the retaining clip;
the retaining clip includes a generally spherical portion thereof for receiving the ball end intersecting a truncated conical portion thereof having a minor diameter thereof connected to the spherical portion and a major diameter thereof adapted for receiving the push rod and for snap engagement with the receptacle in the air valve, the retaining clip further including slots therein for allowing the retaining clip to expand and snap back around the ball end of the push rod and to snap into engagement with the receptacle.

10. The modular valve assembly of claim 9 wherein the spring seat includes an axially extending opening for passage therethrough of the push rod without contact between the push rod and the spring seat.

11. The modular valve assembly of claim 2, defining an axis of motion of the modular valve assembly and further comprising, a push rod extending through the valve seat, the push rod including a radially extending flange for engaging the spring seat and a ball end thereof for snap engagement with the air valve.

12. The modular valve assembly of claim 11 wherein:
the air valve includes a receptacle therein opening along the axis of motion for receiving the push rod; and
the modular valve assembly further includes a retaining clip in the receptacle of the air valve for engaging and connecting the push rod to the air valve.

13. The modular valve assembly of claim 12 wherein:
the ball end of the push rod is adapted for engaging the retaining clip; and
the retaining clip includes a generally spherical portion thereof for receiving the ball end intersecting a truncated conical portion thereof having a minor diameter thereof connected to the spherical portion and a major diameter thereof adapted for receiving the push rod and for snap engagement with the receptacle in the air valve, the retaining clip further including slots therein for allowing the retaining clip to expand and snap back around the ball end of the push rod, and to snap into engagement with the receptacle.

14. The modular valve assembly of claim 11 wherein the spring seat includes a flange for retaining the FCV spring between the flange and the FCV, to thereby urge the FCV to move along the axis of motion toward the air valve seat on the air valve.

15. The modular valve assembly of claim 14 wherein the flange of the spring seat further retains the air valve spring between the flange and the FCV support, to thereby urge the spring retainer to move along the axis of motion away from the FCV support, and through the snap connection to pull the air valve toward the FCV and FCV support.

16. A method for assembling a vacuum booster, the method comprising:
fabricating a modular valve assembly including, an air valve adapted for receiving a push rod, a floating control valve (FCV), a floating control valve (FCV) support, an air valve spring, a floating control valve (FCV) spring, and a spring seat operatively attached by a snap connection to the air valve, with the snap connection retaining the FCV, FCV support, air valve spring, and FCV spring between the spring seat and the air valve.

17. The method of claim 16 further comprising, installing the modular valve assembly into the vacuum booster, and attaching a push rod to the vacuum booster after the modular valve assembly is installed in the vacuum booster with a second snap connection between the push rod and the air valve.

18. The method of claim 17 further comprising, testing the vacuum booster prior to installing the push rod.

19. The method of claim 16 wherein the modular valve assembly further includes a push rod having an end configured for forming a snap connection to the air valve, and a flange adapted for bearing against the spring seat, and the method includes positioning the air valve, FCV, FCV support, FCV spring, air valve spring, and spring seat in sequential alignment with one another, inserting the end of the push rod through the FCV, FCV support, FCV spring, air valve spring, and spring seat, and completing the snap connection of the end of the push rod with the air valve.

20. A vacuum booster comprising:
a power piston; and
a modular valve assembly installed in the power piston;
the modular valve assembly including an air valve adapted for receiving a push rod, a floating control valve (FCV), a floating control valve (FCV) support attached to the FCV, an air valve spring, a floating control valve (FCV) spring, and a spring seat operatively attached by a snap connection to the air valve, with the snap connection retaining the FCV, FCV support, air valve spring, and FCV spring between the spring seat and the air valve.
